(19) United States
(12) Patent Application Publication
(10) Pub. No.: US 2010/0039070 A1
(43) Pub. Date: Feb. 18, 2010

(54) Storage device alternating recharging process

(76) Inventor: Michael Steven Hargett, Salem, OR (US)

Correspondence Address: Michael Steven Hargett, 5116 Norma CT. S.E., Salem, OR, 97306-1574, US

(21) Appl. No.: 12/228,855

(22) Filed: Aug. 18, 2008

(51) Int. Cl. H02J 7/00; F17C 1/00

(52) U.S. Cl. 320/137; 220/581; 180/65.1

(57) ABSTRACT

An electricity or compressed air storage device is used to store electricity or air that can be used when needed in electronics, electric equipment, electric motors, electric vehicles, compressed air tools and compressed air-driven vehicles. Compressed air vehicles are being developed, tested and developed at the present. There are broad varieties of applications for these two types storage devices. To mention specifically, electrical devices that require stored electricity in their operation. The two most commonly used are the battery and capacitor. Using the battery and the capacitor are examples in the application of electricity. These 2 storage devices are used in all types of applications where stored electricity is needed. The common use is to have the electricity storage device dispense its stored electricity for use in the operation of various types of electric equipment, electric vehicles and other electronic devices as a means of powering them. The powering of these different types of devices has been limited to the storage capacity of the storage device. The difficulty in these electricity storage devices are that once they have been depleted, they have to be recharged. The recharging time has created great periods of which these electric devices have to be taken out of service and cannot be used. This down time is to either recharge the existing electricity storage device or replace it with a new fully charged one. This has limited the operation of the vehicles usefulness both in the electric vehicle and the presently developed compressed air vehicle. The same deficiency that applies to use in electric devices applies to the use of compressed air devices. This means by recharging the storage devices onboard, then alternating these storage devices in the sequence of charge, discharge and recharge will allow the use of the vehicles for a greater distance of operation and time they can stay in operation.

This Invention consists of the means to allow the continued use of electric storage and compressed air devices without having to stop the operation of the device to have their systems recharged, in the use of electricity storage devices to either be recharged or replaced with a fully recharged storage device. This same interruption of service applies to compressed air use, using the example of the electric vehicle and compressed air vehicles in their inability in traveling long distances and the down time in operation due to depleted electricity storage devices and compressed air storage tanks. The Storage Device Alternating Recharging Process can overcome these dilemmas buy allowing the electric and compressed air vehicles to alternate electric and air storage devices by recharging them while the vehicle is in operation. The vehicles, as an example, can only travel a limited distance on one storage device fully charged. By alternating the storage devices for electric powered vehicles such as batteries or capacitors as well as compressed air powered vehicles which are air tanks. The Storage Device Alternating Recharging Process lengthens the operation time and distance of travel; this process of recharging the depleted storage devices once they are used and switching to a fully charged storage device to power the electric or compressed air vehicle. This process repeats itself over and over. The depleted storage devices are charged from an on board charging system. The Storage Device Alternating Recharging Process works by using a series of storage devices and their use is in a series one at a time. The process can consist of at least 2 storage devices. As the example has shown they are used in the operation or driving of an electric or compressed air vehicle greater distances. The process starts with the use of one storage device, when depleted the system switches to the second storage device that is next in line to be used.

This invention can have as many storage devices as needed in requiring the vehicle to operate at its maximum time and distance. The Storage Device Alternating Recharging Process is a means to increase the distances and time of uses of many different types of devices that require electricity or compressed air by recharging these storage devices as they are depleted onboard with an onboard charging device. The onboard system of the means to recharge these storage devices will allow the vehicles to continue for greater distances. The Storage Device Alternating Recharging Process repeats itself of charge, discharge and recharge.

### FIELD OF INVENTION

This Invention relates to: (1) The need to have an electric or compressed air vehicle travel farther distances than before were impossible to attain. (2) This Invention also addresses and shortens the length of time required to recharge both electric vehicles' batteries and compressed air tanks without taking the vehicles out of operation. (3) This Invention addresses the need to have an environmentally safer form of travel. (4) This Invention decreases the need of foreign fossil fuels, which helps the United States become less dependent on those nations that are considered to be unfriendly, hostile adversaries to our global policy and national security.

### DESCRIPTION OF PRIOR ART AND CROSS REFERENCE APPLICATIONS AND PATENTS

There is no Prior Art to report.

There are no other Patents to report in the Patent Search. There were 0 results of any additional Patents in the search.

No Prior Art from any other sources. There are no other Patents or any Prior Art to my knowledge to report. No Prior Art or Patents connected to this Invention.

In the Preferred Embodiment, we are using the drawing to simulate both electric and compressed air vehicles and the four parts that simulate the storage devices, such as batteries and air tanks. In the broader scope, the inventive process would allow any type of energy storage device to be used in the inventive process. Both these two types of vehicle have limited range. The Storage Device Alternating Recharging Process allows the distance and time needed to make these types of vehicles the means to be cost effective in distance and time of travel. It is certain that a means of extending the life of an electric vehicle's batteries or capacitors would make the electric vehicle a more efficient means of travel than a fossil fuel vehicle. This cost saving process would also allow the same for a compressed air vehicle. The cost reduction in transporting people and goods would be dropped dramatically with the electric and compressed air vehicles. As you can see in the drawing of the vehicle, FIG. (1) #1 shows the use of 4 batteries, capacitors or compressed air storage tanks, or any type of storage device to power the vehicle. These storage devices can be clumped together in packs. Individually or in packs they are used by alternating their use. The others that are depleted are being simultaneously recharged in the Battery Alternating Recharging Process, then bringing them back on line when recharged to be reused in powering the electric or compressed air vehicle. This process meets the needs in extending these vehicles' time and distance they can travel.

The Storage Device Alternating Recharging Process works as a means to extend the travel time and distance of an electricity and compressed air vehicles. The process works this way: using an electric vehicle as the example equipping the electric vehicle with 4 battery or 4 packs of batteries which are in the Description of the Drawing. The four battery packs also can simulate 4 compressed air storage tanks as well in the use of compressed air vehicle, or any other type of vehicle or machinery where the inventive process may be used. As for this application, these batteries or either compressed air storage tanks are used in the inventions description only. In the drawing, they are numbered 1 through 4. These are to be considered batteries or compressed air storage tanks as the examples to the storage device alternating recharging process. In the invention's use to allow the process to cycle, there can be as many as 2 devices or as many as desired to achieve a certain distance or time of travel. By using multiple battery packs or compressed air tanks you can extend the time and distance traveled by the electric or a compressed air vehicle.

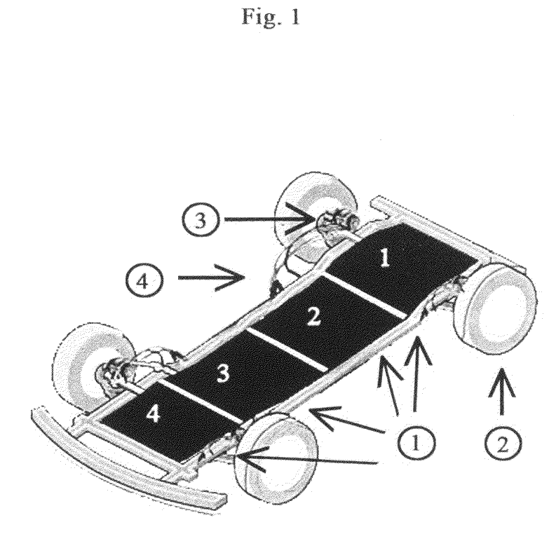

Using the drawing as an example to explain the process. In the drawing (FIG. 1), there are 4 battery sections starting at #1 of the 4 battery sections or either 4 compressed air tanks as a simulation of the process. This drawing uses 4 for this application. There can be as many batteries or storage air tanks as needed to allow the process to recycle itself in the discharge and recharge. FIG. 1, #2 is a standard automotive wheel and rubber tire. FIG. 1, #3 you can see the electricity producing devices that are attached to the electric vehicles wheels. These devices in the drawing are alternators specifically for this patent application. The alternator supplies the electric current that is needed to operate the Storage Device Alternating Recharging Process. However, the devices may be of other types (generators, for example) or other devices that produce electric current. These devices that are show also can simulate air compressors that would be powered by electricity to produce compressed air. FIG. 1, #4 shows the electric wires that supply or carry the electric current from the alternators to the batteries. These wires carry the electric current to supply the depleted batteries once they have been discharged of their electricity. These same wires supply or carry the electric current that is needed for the Storage Device Alternating Recharging Process to be successful. FIG. 1, #4 can also simulate air hoses that would supply the compressed air to the storage tanks in the process.

The Storage Device Alternating Recharging Process will create the desired time and distance that an electric vehicle, compressed air vehicle or any other storage device used to power a vehicle with the inventive process.

Using the electric vehicle with its storage devices which are named batteries. To use the compressed air vehicle as an example, we would then use compressed air tanks as they are the storage devices. In the process these air storage tanks serve the same purposes as those of batteries in connection with supplying the stored power as a means to propel the vehicle. In essence, these are the power storage units that supply the types of power in either vehicle that would be used as the example.

Using the electric vehicle as the example, this is how the inventive process works:

Start off by using the #1 Battery Pack. While the Vehicle is being driven by the #1 Battery Pack, the Electric Vehicle will sense when #1 Battery Pack starts to be depleted. When the Electric Vehicle senses #1's depletion, then the #2 Battery Pack comes on line to be used to power the Electric Vehicle, as #2 Battery Pack starts to be used, the #1 Battery Pack goes into the Recharging Phase of the Process. As #2 begins to be depleted the Electric Vehicle senses the depletion of #2. The #3 Battery Pack comes on line to be used. As #3 is being used, #2 Battery Pack enters the recharging process. At the time #3 Battery Pack is being depleted the Electric Vehicle senses that depletion of #3.

#4 Battery Pack comes on line to be used. #3 Battery Pack enters the recharging process. When #4 Battery Pack is depleted then the Electric Vehicle senses the depletion of #4. At that point the Electric Vehicle switches back to #1 Battery Pack. When the Vehicle switches back to #1 Battery Pack it is charged and ready to be used in powering the Electric Vehicle. When #1 comes on line in powering the Electric Vehicle, #4 enters the recharging process and the Battery Alternating Recharging Process starts over. The Process repeats itself over.

FIG. (1) shows a simplified overhead view of the electric or compressed air vehicle chassis looking down from above. This downward overhead view is without the exterior vehicle body cover, seats, steering wheel, electric motor, transmission and other vehicle parts that are in a standard electric or compressed air vehicle. The simplified view is to eliminate all other components so that the focus can be directed entirely on the Storage Device Alternating Recharging Process with its components. FIG. (1) shows only the basic components that are required in the function in the Storage Device Alternating Recharging Process.

Number 1 in FIG. (1) shows the 4 storage devices in the vehicle. These 4 storage devices are either electric vehicle which simulate batteries or capacitors. Compressed air vehicle air tanks. These sections represent the storage devices in the Storage Device Alternating Recharging Process. 4 battery packs are used in number 1 of FIG. (1) only for the description of the this drawing. It must be noted that the number of batteries is determined by the Electric Vehicles design in attaining distance and time traveled. The number of batteries can be as many as 2, or as many as needed in any desired application.

Number 2 in FIG. (1) shows a vehicle standard tire and wheel. This type tire and wheel are the same as any fossil fuel vehicle that is being driven today.

Number 3 in FIG. (1) shows an electricity producing device to charge the electric vehicle in this drawing. This same drawing can simulate an air compressor that would charge the compressed air vehicles tanks. FIG. (1). There are many types of electricity producing devices available that could be applied to the electric vehicle aspect of the; Storage Device Alternating Recharging Process. It is not necessary to name all of those in this application. Any device that produces the sufficient amounts of electricity can be used. The compressed air driven vehicle also has many types and sizes of compressors that would provide the compression to recharge the air tanks. In FIG. (1) these electricity and or air compressors produce either the air or electricity to allow the; Storage Device Alternating Recharging Process to fulfill its cycle of charge, discharge and recharge of either the electric vehicles batteries, capacitors or the compressed air vehilces air tanks.

Number 4 in FIG. (1) shows the simple wiring for the electric vehicle or the air hoses for a copressed air driven vehicle, that is required to operate the Storage Device Alternating Recharging Process. FIG. (1). These electric wires or air hoses run from the vehicles electric generator or the air compressor depending on which type of vehicle is being driven. Producing the air or electricity that will allow the Process to cycle itself.

1. The use of 2 or more storage devices in the Storage Device Alternating Recharging Process. These storage devices can store any type of energy that can be stored. The energy can be any element; gas, solid matter or electricity (anything that can be recharged). The Process starts with two storage devices, such as a battery or capacitor for the storage of electricity and two storage tanks for compressed air. When number 1 storage device is depleted, number 2 storage device comes into use and number 1 goes into recharge phase. When number 2 storage device is depleted number 1 is charged and comes into use. Thus, the description title of the invention the: Storage Device Alternating Recharging Process.
These storage devices are made up of individual components such as batteries and capacitors; for air, air tanks. The number of storage devices varies in each application. The number of devices is determined by reaching the desired distance and time of travel. This number of storage devices can be as many as 2, or an infinite number according to the desired application to attain specific needs.

2. The alternating use of storage devices for use and recharging for reuse in a continuous process while in motion or while being driven, in essence when in operation. These vehicles do not have to be stopped or parked and connected to a power source for the means of recharging their storage devices. This Process will allow the freedom from having to take the vehicle out of operation to charge the storage devices.

3. This claim is the broad use of; the Storage Device Alternating Recharging Process described in this Patent application. For an example, airplanes, helicopters, military vehicles of all types that could be powered by electricity or compressed air, or any other type of stored rechargeable material, gas or matter. The process for vehicles that are electric would convert them into mobile power stations. As an example, the electric Humvee would become a mobile power station that would supply electric power for all needs in the field of operations, such as war zones. Other examples are all types of seagoing vessels, military, passenger and freight vehicles, trains, passenger or freight. Any of these types of vehicles and modes of transportation could be either electric or compressed air-powered. The Storage Device Alternating Recharging Process concerning electric power for apartment complexes or a housing development such as a subdivision. The process would work as supplying electricity to power the homes and apartments with a central power station supplying the power to operate the electrical version of the Storage Device Alternating Recharging Process. One last example: a hiker or military person would use the electrical version as a nano power source in a back pack for electric power in desolate areas. This application would power all the individuals electric power needs, camping, or in the hostile field of operations.
